(19) United States
(12) Patent Application Publication
(10) Pub. No.: US 2023/0025049 A1
(43) Pub. Date: Jan. 26, 2023

(54) MULTI-MODAL INPUT-BASED SERVICE PROVISION DEVICE AND SERVICE PROVISION METHOD

(71) Applicant: LG ELECTRONICS INC., Seoul (KR)

(72) Inventors: Kihyeon KIM, Seoul (KR); Euihyeok LEE, Seoul (KR)

(73) Assignee: LG ELECTRONICS INC., Seoul (KR)

(21) Appl. No.: 17/758,476

(22) PCT Filed: Nov. 4, 2020
(86) PCT No.: PCT/KR2020/015343

§ 371 Date: Jul. 7, 2022

Related U.S. Application Data
(60) Provisional application No. 62/957,816, filed on Jan. 7, 2020.

(51) Int. Cl. B60W 50/08; G06F 3/041

(52) U.S. Cl. CPC B60W 50/08; G06F 3/041

(57) ABSTRACT

Provided is a multi-modal input-based service device and service provision method. A service provision device according to the present specification may comprise: a storage unit for storing multiple applications; a user input unit for receiving a user input including at least one of a voice command and a touch input; and a processor which is functionally connected to the multiple applications, and controls execution of at least one application on the basis of the user input so that dialogs generated by the multiple applications are output in consideration of a pattern of the user input, wherein the processor may analyze an execution screen of a particular application and the user input on the execution screen, infer the intention of the user input, and control a dialog corresponding to the inferred intention to be generated in an application corresponding to the inferred intention.

### TECHNICAL FIELD

This specification relates to a service provision device and service provision method based on a multi-modal input, and more particularly, to a service provision device and service provision method based on the contents of an execution screen and a multi-modal input.

### BACKGROUND ART

Vehicles may be classified into an internal combustion engine vehicle, an external composition engine vehicle, a gas turbine vehicle, an electric vehicle, etc. depending on the type of motors used therefor.

In multi-modal input-based service provision for a vehicle, the existing voice assistant operates in a way to determine the final execution operation by hosting a dialogue speech with a user and deliver the determined operation to another function or another application within a system, as an independent application. Furthermore, the existing voice assistant does not have consistency of a GUI-based common application user experience and a user experience through the voice assistant, and has a difference in their functions.

In order to solve this, there is a need for a voice assistant capable of driving applications having different functions.

### DISCLOSURE

### Technical Problem

An object of this specification is to more efficiently provide a service based on a multi-modal input.

Furthermore, an object of this specification is to drive functions of all applications having various functions by only one voice assistant.

Objects to be solved in the present disclosure are not limited to the aforementioned objects, and the other objects not described above may be evidently understood from the following detailed description of the present disclosure by a person having ordinary knowledge in the art to which the disclosure pertains.

### Technical Solution

In order to solve the object, according to this specification, a service provision device based on a multi-modal input includes a storage unit configured to store a plurality of applications, a user input unit configured to receive a user input including at least one of a voice command or a touch input, and a processor functionally connected to the plurality of applications and configured to control the execution of at least one application based on the user input so that a dialog generated by the plurality of applications may be outputted by considering a pattern of the user input. The processor may be configured to infer intent of the user input by analyzing an execution screen of a specific application and the user input on the execution screen and to control an application corresponding to the inferred intent to generate a dialog corresponding to the inferred intent.

Furthermore, the processor may be configured to control the dialog to be generated as a voice based on the user input being the voice command.

Furthermore, the user input may further include motion information.

Furthermore, the processor may be configured to infer the intent by additionally considering the motion information.

Furthermore, the processor may be configured to activate or deactivate the user input unit based on a preset condition.

In this case, the processor may be configured to control a previous screen of the execution screen to be stored in the memory.

Furthermore, the processor may be configured to infer the intent of the user input by analyzing the previous screen and the user input.

Furthermore, the processor may be configured to extract information on the execution screen and to infer the intent of the user input by analyzing the information and the user input.

Furthermore, the processor may be configured to control the user input unit to switch into a voice recognition mode or a touch mode.

Furthermore, the processor may be configured to infer the intent of the user input by analyzing the execution screen based on the intent of the user input being not inferred by analyzing the user input.

Furthermore, in order to solve the object, according to this specification, a service provision method based on a multi-modal input includes receiving a user input including at least one of a voice command or a touch input, inferring intent of the user input by analyzing an execution screen of a specific application and the user input on the execution screen, controlling the application corresponding to the inferred intent to generate a dialog corresponding to the inferred intent, and controlling the execution of at least one application so that the generated dialog may be outputted by considering a pattern of the user input.

Furthermore, the dialog may be outputted as a voice based on the user input being the voice command.

Furthermore, the user input may further include motion information.

Furthermore, the inferring of the intent of the user input may include inferring the intent by additionally considering the motion information.

Furthermore, the inferring of the intent of the user input may include receiving the user input based on a user input unit being activated under a preset condition.

Furthermore, the inferring of the intent of the user input may include storing a previous screen of the execution screen in a memory, and inferring the intent of the user input by analyzing the previous screen and the user input.

Furthermore, the inferring of the intent of the user input may include extracting information on the execution screen, and inferring the intent of the user input by analyzing the information and the user input.

Furthermore, the receiving of the user input may include controlling a user input unit to switch into a voice recognition mode and a touch mode based on a preset condition, and receiving the user input.

Furthermore, the inferring of the intent of the user input may include inferring the intent of the user input by analyzing the execution screen based on the intent of the user being not inferred by analyzing the user input.

### Advantageous Effects

This specification has an effect in that it can more efficiently provide a service based on a multi-modal input.

Furthermore, this specification has an effect in that it can drive functions of all applications having various functions by only one voice assistant.

Furthermore, this specification has an effect in that it can improve the driving stability of a vehicle and user convenience through a proper GUI-VUI mode-automatic change and integration depending on a vehicle condition.

Effects which may be obtained in this specification are not limited to the aforementioned effects, and other technical effects not described above may be evidently understood by a person having ordinary knowledge in the art to which the present disclosure pertains from the following description

### DESCRIPTION OF DRAWINGS

The accompany drawings, which are included as part of the detailed description in order to help understanding of this specification, provide embodiments of the present disclosure and describe the technical characteristics of the present disclosure along with the detailed description.

FIG. 1 is a diagram illustrating a vehicle according to an embodiment of the present disclosure.

FIG. 2 is a control block diagram of a vehicle according to an embodiment of the present disclosure.

FIG. 3 is a control block diagram of an autonomous vehicle according to an embodiment of the present disclosure.

FIG. 4 is a signal flowchart of an autonomous vehicle according to an embodiment of the present disclosure.

FIG. 5 is a diagram illustrating a service provision device based on a multi-modal input according to this specification.

FIG. 6 is a diagram illustrating a service provision method based on a multi-modal input according to this specification.

FIGS. 7 to 10 are diagrams illustrating detailed scenarios of the service provision device and the service provision method according to this specification.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus may be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Driving

(1) Exterior of Vehicle

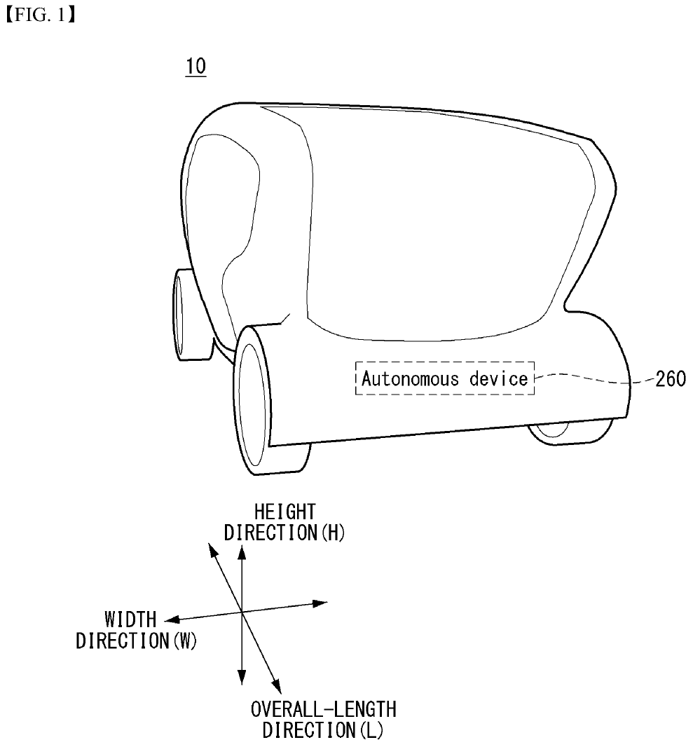

FIG. 1 is a diagram showing a vehicle according to an embodiment of the present disclosure.

Referring to FIG. 1, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

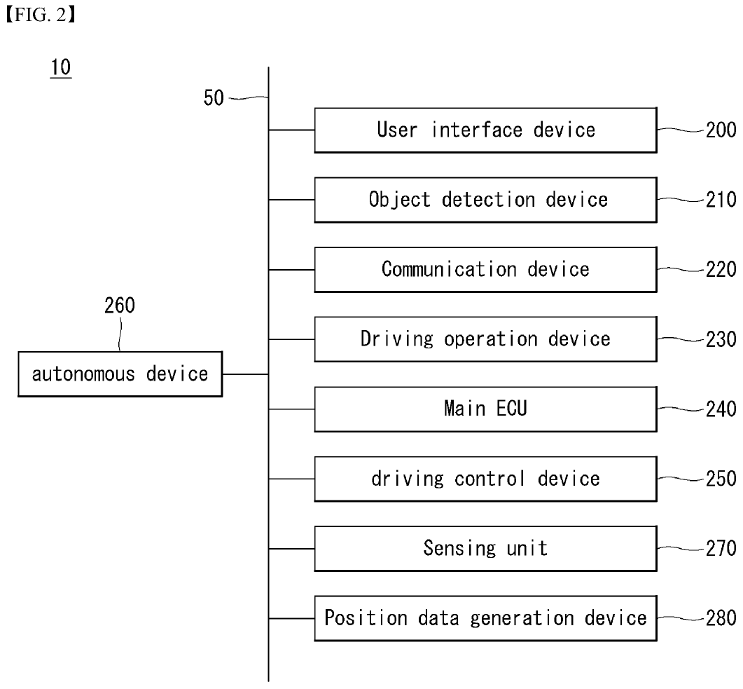

FIG. 2 is a control block diagram of the vehicle according to an embodiment of the present disclosure.

Referring to FIG. 2, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 may receive user input and provide information generated in the vehicle 10 to the user. The vehicle 10 may realize a user interface (UI) or user experience (UX) through the user interface device 200. The user interface device 200 may include an input device, an output device and a user monitoring device.

2) Object Detection Device

The object detection device 210 may generate information about objects outside the vehicle 10. Information about an object may include at least one of information on presence or absence of the object, positional information of the object, information on a distance between the vehicle 10 and the object, and information on a relative speed of the vehicle 10 with respect to the object. The object detection device 210 may detect objects outside the vehicle 10. The object detection device 210 may include at least one sensor which may detect objects outside the vehicle 10. The object detection device 210 may include at least one of a camera 12, a radar, a lidar, an ultrasonic sensor and an infrared sensor. The object detection device 210 may provide data about an object generated on the basis of a sensing signal generated from a sensor to at least one electronic device included in the vehicle 10.

2.1) Camera

The camera 12 may generate information about objects outside the vehicle 10 using images. The camera 12 may include at least one lens, at least one image sensor, and at least one processor which is electrically connected to the image sensor, processes received signals and generates data about objects on the basis of the processed signals.

The camera 12 may be at least one of a mono camera 12, a stereo camera 12 and an around view monitoring (AVM) camera 12. The camera 12 may acquire positional data of objects, information on distances to objects, or information on relative speeds with respect to objects using various image processing algorithms. For example, the camera 12 may acquire information on a distance to an object and information on a relative speed with respect to the object from an obtained image on the basis of change in the size of the object over time. For example, the camera 12 may acquire information on a distance to an object and information on a relative speed with respect to the object through a pin-hole model, road profiling, or the like. For example, the camera 12 may acquire information on a distance to an object and information on a relative speed with respect to the object from a stereo image obtained from a stereo camera on the basis of disparity information.

The camera 12 may be attached at a portion of the vehicle 10 at which FOV (field of view) may be secured in order to photograph the outside of the vehicle. The camera 12 may be disposed in proximity to the front windshield inside the vehicle 10 in order to acquire front view images of the vehicle 10. The camera 12 may be disposed near a front bumper or a radiator grill. The camera 12 may be disposed in proximity to a rear glass inside the vehicle in order to acquire rear view images of the vehicle 10. The camera 12 may be disposed near a rear bumper, a trunk or a tail gate. The camera 12 may be disposed in proximity to at least one of side windows inside the vehicle 10 in order to acquire side view images of the vehicle 10. Alternatively, the camera 12 may be disposed near a side mirror, a fender or a door.

2.2) Radar

The radar may generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar may detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle 10 in order to detect objects positioned in front of, behind or on the side of the vehicle 10.

2.3) Lidar

The lidar may generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle 10 according to light steering. The vehicle 10 may include a plurality of non-drive type lidars. The lidar may detect an object through a laser beam on the basis of TOF (Time of Flight) or phase shift and detect the position of the detected object, a distance to the detected object and a relative speed with respect to the detected object. The lidar may be disposed at an appropriate position outside the vehicle 10 in order to detect objects positioned in front of, behind or on the side of the vehicle 10.

3) Communication Device

The communication device 220 may exchange signals with devices disposed outside the vehicle 10. The communication device 220 may exchange signals with at least one of infrastructure (e.g., a server and a broadcast station), another vehicle 10 and a terminal. The communication device 220 may include a transmission antenna, a reception antenna, and at least one of a radio frequency (RF) circuit and an RF element which may implement various communication protocols in order to perform communication.

Furthermore, the communication device 220 may exchange signals with an external device through a V2X (vehicle-to-everything) communication technology. V2X communication may be provided through a PC5 interface and/or a Uu interface.

Meanwhile, a next-generation radio access technology may be referred to as a new RAT (new radio access technology) or NR (new radio). Even in the NR, V2X (vehicle-to-everything) communication may be supported.

5G NR is a subsequent technology of LTE-A, and is a new clean-slate form of a mobile communication system having characteristics, such as high performance, low latency, and high availability. 5G NR may use all of available spectrum resources, such as frequency bands from a low frequency band of less than 1 GHz to an intermediate frequency band of 1 GHz to 10 GHz and a high frequency (millimeter waves) band of 24 GHz or more.

In order to clarify a description, LTE-A or 5G NR is chiefly described, but the technical spirit of the present disclosure is not limited thereto.

For example, the communication device 220 may exchange signals with external devices on the basis of C-V2X (Cellular V2X). For example, C-V2X may include sidelink communication on the basis of LTE and/or sidelink communication on the basis of NR. Details related to C-V2X will be described later.

For example, the communication device 220 may exchange signals with external devices on the basis of DSRC (Dedicated Short Range Communications) or WAVE (Wireless Access in Vehicular Environment) standards on the basis of IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that may use a frequency of 5.9 GHz and have a data transfer rate in the range of 3 Mbps to 27 Mbps. IEEE 802.11p may be combined with IEEE 1609 to support DSRC (or WAVE standards).

The communication device 220 of the present disclosure may exchange signals with external devices using only one of C-V2X and DSRC. Alternatively, the communication device 220 of the present disclosure may exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 may control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 may control vehicle driving devices on the basis of signals received by the autonomous device 260. For example, the driving control device 250 may control a power train, a steering device and a brake device on the basis of signals received by the autonomous device 260.

7) Autonomous Device

The autonomous device 260 may generate a route for self-driving on the basis of obtained data. The autonomous device 260 may generate a driving plan for traveling along the generated route. The autonomous device 260 may generate a signal for controlling movement of the vehicle 10 according to the driving plan. The autonomous device 260 may provide the signal to the driving control device 250.

The autonomous device 260 may implement at least one ADAS (Advanced Driver Assistance System) function. The ADAS may implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 may perform switching from a self-driving mode to a manual driving mode or switching from the manual driving mode to the self-driving mode. For example, the autonomous device 260 may switch the mode of the vehicle 10 from the self-driving mode to the manual driving mode or from the manual driving mode to the self-driving mode on the basis of a signal received from the user interface device 200.

8) Sensing Unit

The sensing unit 270 may detect a state of the vehicle 10. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 may generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 may generate position data of the vehicle 10. The position data generation device 280 may include at least one of a global positioning system (GPS) and a differential global positioning system (DGPS). The position data generation device 280 may generate position data of the vehicle 10 on the basis of a signal generated from at least one of the GPS and the DGPS. According to an embodiment, the position data generation device 280 may correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 may exchange signals through the internal communication system 50. The signals may include data. The internal communication system 50 may use at least one communication protocol (e.g., CAN, LIN, FlexRay, MOST or Ethernet).

(3) Components of Autonomous Device

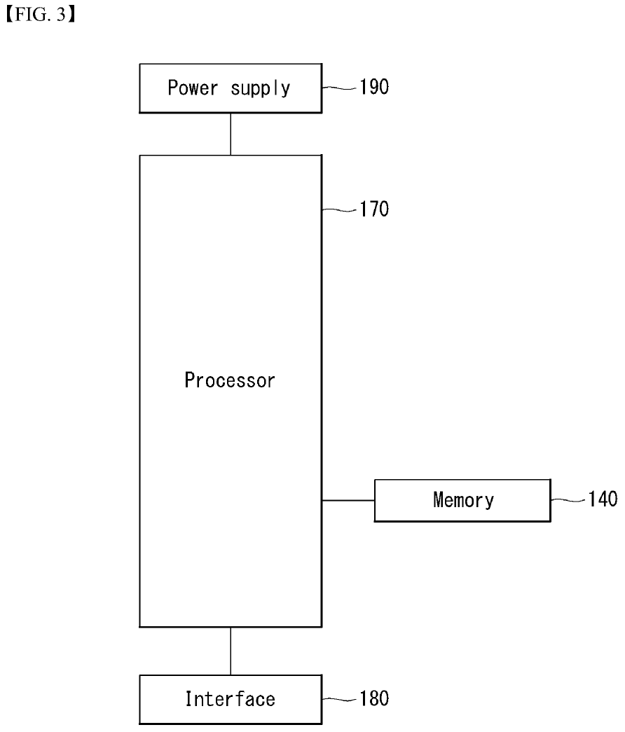

FIG. 3 is a control block diagram of the autonomous device according to an embodiment of the present disclosure.

Referring to FIG. 3, the autonomous device 260 may include a memory 140, a processor 170, an interface 180 and a power supply 190.

The memory 140 is electrically connected to the processor 170. The memory 140 may store basic data with respect to units, control data for operation control of units, and input/output data. The memory 140 may store data processed in the processor 170. Hardware-wise, the memory 140 may be configured as at least one of a ROM, a RAM, an EPROM, a flash drive and a hard drive. The memory 140 may store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 may exchange signals with at least one electronic device included in the vehicle 10 in a wired or wireless manner. The interface 180 may exchange signals with at least one of the object detection device 210, the communication device 220, the driving operation device 230, the main ECU 240, the driving control device 250, the sensing unit 270 and the position data generation device 280 in a wired or wireless manner. The interface 180 may be configured using at least one of a communication module, a terminal, a pin, a cable, a port, a circuit, an element and a device.

The power supply 190 may provide power to the autonomous device 260. The power supply 190 may be provided with power from a power source (e.g., a battery) included in the vehicle 10 and supply the power to each unit of the autonomous device 260. The power supply 190 may operate according to a control signal supplied from the main ECU 240. The power supply 190 may include a switched-mode power supply (SMPS).

The processor 170 may be electrically connected to the memory 140, the interface 180 and the power supply 190 and exchange signals with these components. The processor 170 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 may be operated by power supplied from the power supply 190. The processor 170 may receive data, process the data, generate a signal and provide the signal while power is supplied thereto.

The processor 170 may receive information from other electronic devices included in the vehicle 10 through the interface 180. The processor 170 may provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

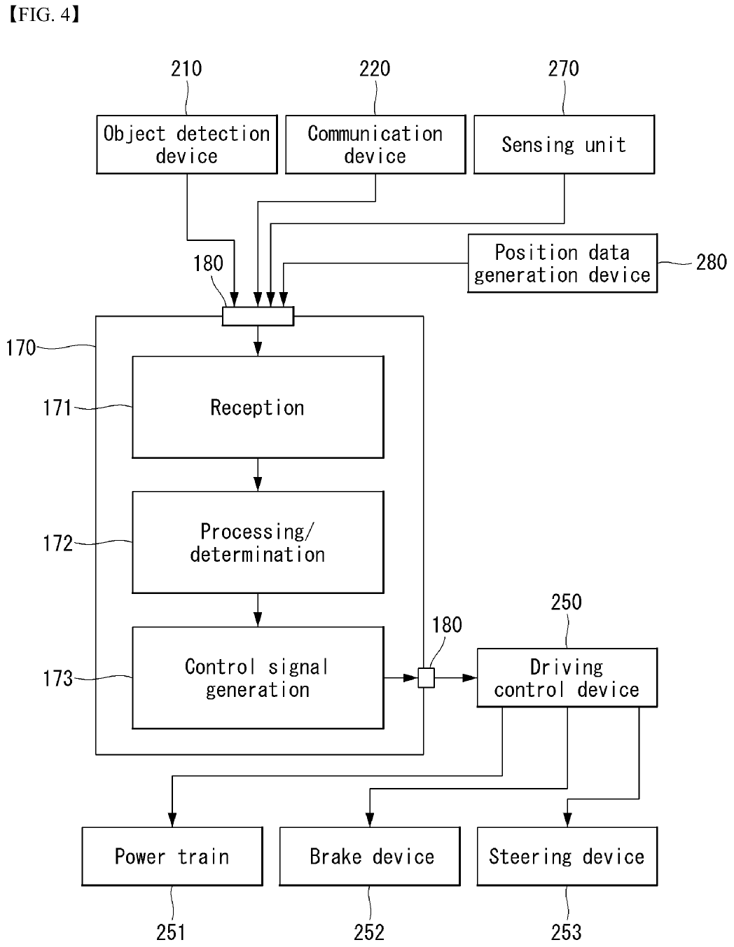

FIG. 4 is a diagram showing a signal flow in an autonomous vehicle according to an embodiment of the present disclosure.

1) Reception Operation

Referring to FIG. 4, the processor 170 may perform a reception operation. The processor 170 may receive data from at least one of the object detection device 210, the communication device 220, the sensing unit 270 and the position data generation device 280 through the interface 180. The processor 170 may receive object data from the object detection device 210. The processor 170 may receive HD map data from the communication device 220. The processor 170 may receive vehicle state data from the sensing unit 270. The processor 170 may receive position data from the position data generation device 280.

2) Processing/Determination Operation

The processor 170 may perform a processing/determination operation. The processor 170 may perform the processing/determination operation on the basis of traveling situation information. The processor 170 may perform the processing/determination operation on the basis of at least one of object data, HD map data, vehicle state data and position data.

2.1) Driving Plan Data Generation Operation

The processor 170 may generate driving plan data. For example, the processor 170 may generate electronic horizon data. The electronic horizon data may be understood as driving plan data in a range from a position at which the vehicle 10 is located to a horizon. The horizon may be understood as a point a predetermined distance before the position at which the vehicle 10 is located on the basis of a predetermined traveling route. The horizon may refer to a point at which the vehicle may arrive after a predetermined time from the position at which the vehicle 10 is located along a predetermined traveling route.

The electronic horizon data may include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be on the basis of data stored in at least one memory included in the vehicle 10.

The road data may include at least one of road slope data, road curvature data and road speed limit data. The road data may further include no-passing zone data. The road data may be on the basis of data received from an external server through the communication device 220. The road data may be on the basis of data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be on the basis of data received from an external server through the communication device 220.

The dynamic data may include various types of dynamic information which may be generated on roads. For example, the dynamic data may include construction information, variable speed road information, road condition information, traffic information, moving object information, etc. The dynamic data may be on the basis of data received from an external server through the communication device 220. The dynamic data may be on the basis of data generated in the object detection device 210.

The processor 170 may provide map data in a range from a position at which the vehicle 10 is located to the horizon.

2.1.2) Horizon Path Data

The horizon path data may be explained as a trajectory through which the vehicle 10 may travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road may be calculated to be higher than a probability of selecting the second road.

The horizon path data may include a main path and a sub-path. The main path may be understood as a trajectory obtained by connecting roads having a high relative probability of being selected. The sub-path may be branched from at least one decision point on the main path. The sub-path may be understood as a trajectory obtained by connecting at least one road having a low relative probability of being selected at at least one decision point on the main path.

3) Control Signal Generation Operation

The processor 170 may perform a control signal generation operation. The processor 170 may generate a control signal on the basis of the electronic horizon data. For example, the processor 170 may generate at least one of a power train control signal, a brake device control signal and a steering device control signal on the basis of the electronic horizon data.

The processor 170 may transmit the generated control signal to the driving control device 250 through the interface 180. The driving control device 250 may transmit the control signal to at least one of a power train 251, a brake device 252 and a steering device 254.

Hereinafter, a service provision device based on a multi-modal input according to a preferred first embodiment of this specification is described in detail as follows on the basis of the aforementioned contents.

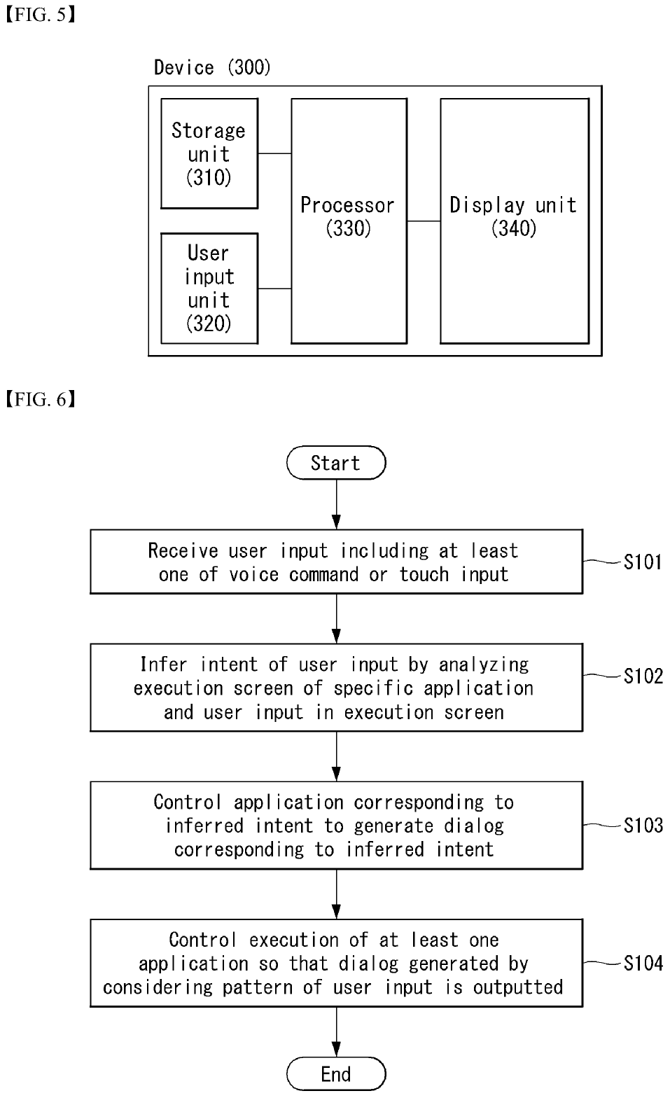

FIG. 5 is a diagram illustrating a service provision device based on a multi-modal input according to this specification.

According to FIG. 5, the service provision device based on a multi-modal input may include a storage unit, a user input unit, and a processor. Furthermore, the service provision device based on a multi-modal input may further include a display unit. Furthermore, the service provision device based on a multi-modal input according to this specification may be installed in a vehicle.

The storage unit 310 stores data that supports various functions of the device 300. The storage unit 310 may store multiple application programs (or applications) driven in the device 300, data or instructions for an operation of the device 300. At least some of such application programs may be downloaded from an external server through wireless communication. Meanwhile, the application program may be stored in the storage unit 310, may be installed on the device 300, and may be driven to perform an operation (or function) of the device 300 by the processor 330.

The storage unit 310 may include at least one type of storage medium among a flash memory type, a hard disk type, an SSD type (solid state disk type), an SDD type (silicon disk drive type), a multimedia card micro type, a card type memory (e.g., an SD or XD memory), a random access memory (RAM), an SRAM (static random access memory), a read-only memory (ROM), an EEPROM (electrically erasable programmable read-only memory), a PROM (programmable read-only memory), a magnetic memory, a magnetic disk, and an optical disk. Furthermore, the storage unit 310 may include web storage which performs a storage function on the Internet.

The input unit 320 may include a microphone or an audio input unit for a voice input. Furthermore, the input unit 320 may further include a user input unit (e.g., a touch key or a mechanical key) for receiving information from a user. Voice data or touch data collected by the input unit 320 may be analyzed and processed as a control command of the user.

The processor 330 is an element capable of performing an operation and controlling another device 10, and may chiefly mean a central processing unit (CPU), an application processor (AP), a graphics processing unit (GPU), etc. Furthermore, the CPU, the AP or the GPU may include one or more cores therein. The CPU, the AP or the GPU may operate by using an operating voltage and a clock signal. However, the CPU or the AP includes some cores optimized for serial processing, whereas the GPU may include several thousands of small and efficient cores designed for parallel processing.

The display unit 340 may mean a device for receiving screen data from the processor 330 and displaying the screen data so that a user can check the screen data through a sense. The display unit 340 may include a self-emissive display panel or a non-self-emissive display panel. The self-emissive display panel may be exemplified as an OLED panel that does not require a backlight, for example. The non-self-emissive display panel may be exemplified as an LCD panel that requires a backlight, for example, but the present disclosure is not limited thereto.

According to FIG. 5, the storage unit may store a plurality of applications. The user input unit may receive a user input including at least one of a voice command or a touch input. Furthermore, the processor may control the execution of at least one application functionally connected to the plurality of applications stored in the storage unit. Furthermore, the processor may control the execution of at least one application based on a user input so that a dialog generated by the plurality of applications can be outputted by considering a pattern of the user input.

Furthermore, the processor may infer intent of a user input by analyzing an execution screen of a specific application and the user input in the execution screen. In this case, the specific application may be one of a plurality of applications. Furthermore, the processor may control an application corresponding to the inferred intent to generate a dialog corresponding to the inferred intent.

Furthermore, when a user input is a voice input, the processor may control a dialog to be generated as a voice. Furthermore, when a user input is a touch input, a dialog may be outputted as a visual image. This is an example, and may be the other way around.

For example, in a service provision device based on a multi-modal input, which is installed in a navigation device for a vehicle, when a user inputs a voice command (e.g., what time does your destination close?), the voice command may be transmitted to the processor through the user input unit. The processor may analyze a meaning of the voice command through natural language processing. Furthermore, the processor may analyze text displayed on a screen of the navigation device for a vehicle, and may search for a function corresponding to the voice command of the user. The processor may extract information on a POI of the destination in response to the voice command of the user, and may output a corresponding dialog (e.g., We close at 6 p.m.) as a voice.

For example, in a service provision device based on a multi-modal input, which is installed in a navigation device for a vehicle, when a user inputs a voice command (e.g., please select A among A and B), the voice command may be transmitted to the processor through the user input unit. The processor may analyze a meaning of the voice command through natural language processing. Furthermore, the processor may analyze text displayed on a screen of the navigation device for a vehicle, and may search for a function corresponding to the voice command of the user. The processor may obtain information indicating that a button A and a button B are being displayed on an execution screen in response to the voice command of the user. The processor may select the button A in response to the voice command of the user. The processor may output a dialog including contents indicating that the button A has been selected.

In some cases, a user input may further include motion information. In this case, the processor may infer intent by additionally considering the motion information.

For example, a user may issue a command through a voice while drawing a circle (e.g., tell me a parking area nearby (while drawing a concentric circle)). In this case, the motion performed by the user may include various gestures in addition to the circle. If the user simply gives order through a voice while performing a predetermined motion, a more accurate command compared to simply issuing a command through a voice may be delivered to the processor.

The processor may activate or deactivate the user input unit based on a preset condition. For example, in the service provision device based on a multi-modal input which is installed in a navigation device for a vehicle, if the vehicle drives at a given velocity or more (e.g., 80 km/h), for safe driving, the processor may deactivate the user input unit. In particular, the processor may deactivate a function for receiving a touch input.

Furthermore, the processor may control the user input unit to switch its mode into a voice recognition mode and/or a touch mode. For example, in the service provision device based on a multi-modal input which is installed in a navigation device for a vehicle, if the vehicle drives at a given velocity or more (e.g., 80 km/h), for safe driving, the processor may control the user input unit to switch from the touch mode to the voice recognition mode. In contrast, when the vehicle stops, the processor may control the user input unit to switch from the voice recognition mode to the touch mode (or the touch mode and the voice recognition mode).

Furthermore, for example, if the voice recognition mode is started once, the processor may maintain the voice recognition mode of the user input unit until a specific application is terminated.

Furthermore, for example, when an error occurs in receiving a user input through the user input unit, the processor may change a mode of the user input unit into the touch mode. Furthermore, when an error occurs as many as a predetermined number (e.g., twice), the processor may change a mode of the user input unit.

Furthermore, the processor may control a previous screen of an execution screen to be stored in the memory. Accordingly, the processor may infer user intent based on the previous screen that was previously executed in addition to the execution screen that is now being executed.

For example, in the service provision device based on a multi-modal input which is installed in a navigation device for a vehicle, when a user inputs a voice command (e.g., Where's the famous restaurant on the screen?), the voice command may be transmitted to the processor through the user input unit. The processor may analyze a meaning of the voice command through natural language processing. Furthermore, the processor may analyze text displayed on a previous screen of the navigation device for a vehicle, and may search for a POI corresponding to the voice command of the user. The processor may output a dialog according to the POI displayed on the previous screen in response to the voice command of the user.

Furthermore, when storing a previous screen in the memory, the processor may allocate a tag to the previous screen as a time stamp. Accordingly, the processor may easily search the previous screen, if necessary.

Such operations of the processor may be basically used when it is difficult to infer user intent based on only a user input. That is, if user intent is clearly inferred based on only a user input, in order to prevent resource waste, the processor may perform an operation according to the user input.

Furthermore, in order to infer user intent, the processor may receive vehicle state information or user condition information from a vehicle. The vehicle state information may include whether the vehicle autonomously drives or whether the vehicle is manually driven. Furthermore, the vehicle state information may include a location, a speed, a driving state, etc. of the vehicle. Furthermore, the user condition information may include information obtained through a camera installed within the vehicle. The processor may receive an image including a condition of a user through a camera, etc. and may infer a condition of the user by analyzing the corresponding image.

Hereinafter, a preferred second embodiment of this specification is described in detail as follows based on the aforementioned contents.

Furthermore, the subject of execution of a service provision method based on a multi-modal input according to this specification may be a device or processor according to the first embodiment of this specification. Furthermore, contents identical with or redundant with the description of the first embodiment may be omitted hereinafter.

FIG. 6 is a diagram illustrating a service provision method based on a multi-modal input according to this specification.

According to FIG. 6, the service provision method based on a multi-modal input according to this specification may include a step S101 of receiving a user input including at least one of a voice command or a touch input, a step S102 of inferring intent of the user input by analyzing an execution screen of a specific application and the user input in the execution screen, a step S103 of controlling an application corresponding to the inferred intent to generate a dialog corresponding to the inferred intent, and a step S104 of controlling the execution of at least one application so that a dialog generated by considering a pattern of the user input is outputted.

If the user input is a voice command, the dialog may be outputted as a voice. Furthermore, if the user input is a touch input, the dialog may be outputted as a visual image. This is an example, and may be the other way around.

Furthermore, the user input may further include motion information. Accordingly, the step S102 of inferring the intent of the user input may infer the intent by additionally considering the motion information.

Furthermore, the step S101 of receiving the user input may receive the user input when the user input unit is activated based on a preset condition.

For example, when a user touches a voice input button in an interface, the voice input mode may be activated in the user input unit since then. Furthermore, when a user touches an area for a touch input in an interface, the voice input mode may be deactivated, and only the touch input mode may be activated in the user input unit since then.

For example, in the service provision device based on a multi-modal input which is installed in a navigation device for a vehicle, when a user drives a vehicle, the voice input mode may be activated in the user input unit since then.

Furthermore, the step S102 of inferring the intent of the user input may include a step S1021 of storing a previous screen of the execution screen in the memory and a step S1022 of inferring the intent of the user input by analyzing the previous screen and the user input.

Furthermore, the step S1021 of storing the previous screen in the memory may include a step S1021a of allocating a tag to the previous screen as a time stamp and a step S1021b of storing data for the previous screen in the memory along with the allocated tag.

Furthermore, the step S102 of inferring the intent of the user input may include extracting information on the execution screen and inferring the intent of the user input by analyzing the extracting information and the user input.

Furthermore, the step S101 of receiving the user input may include a step S1011 of controlling the user input unit to switch into the voice recognition mode and the touch mode based on a preset condition and a step S1012 of receiving the user input.

Furthermore, the step S102 of inferring the intent of the user input may include inferring the intent of the user input by analyzing the execution screen when not inferring the intent of the user input by analyzing the user input.

An embodiment according to a second embodiment of this specification may be omitted because the embodiment is the same as or redundant with the embodiment of the first embodiment.

Hereinafter, detailed scenarios of embodiments according to this specification are described in detail as follows based on the aforementioned contents.

Furthermore, the detailed scenarios described hereinafter may be identically applied to the first embodiment and the second embodiment, which is evident to those skilled in a corresponding technical field.

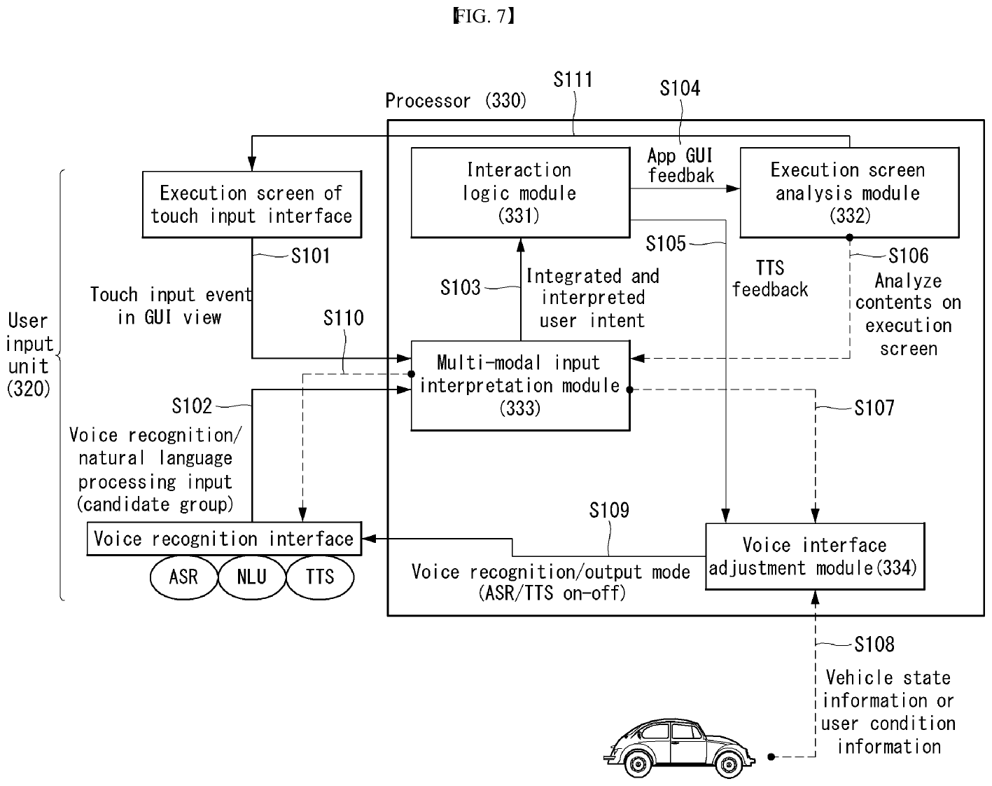

FIGS. 7 to 10 are diagrams illustrating detailed scenarios of the service provision device and the service provision method according to this specification.

FIG. 7 illustrates a detailed scenario when a touch input and a voice command are simultaneously transmitted to the processor.

According to FIG. 7, a touch input generated through an execution screen of a touch input interface (I/F) may be delivered to a multi-modal input interpretation module 333 (S101). A voice command inputted through a voice interface (I/F) may be delivered to the multi-modal input interpretation module 333 (S102). User intent integrated and interpreted in the multi-modal input interpretation module 333 may be delivered to an interaction logic module 331 (S103). The interaction logic module 331 may generate a dialog or may generate APP GUI feedback based on the interpreted intent (S104). Furthermore, based on the interpreted intent, the interaction logic module 331 may generate TTS feedback and deliver the TTS feedback to a user input unit adjustment module 333 (S105).

An execution screen analysis module 332 may analyze content displayed on the execution screen, and may transmit the results of the analysis to the multi-modal input interpretation module 333 (S106). If a user input includes a voice command, the multi-modal input interpretation module 333 may transmit, to the voice interface adjustment module 334, a message to request that the user input needs to be outputted as a voice or an instruction to activate the voice recognition mode (S107). Furthermore, the execution screen analysis module 332 may directly feed the user input back to the execution screen (S111).

The voice interface adjustment module 334 may instruct a voice interface (or the user input unit 320) to activate the voice recognition/output mode (S109). The voice interface adjustment module 334 may determine whether to switch into the voice recognition/output mode by considering state information or user condition information of a vehicle (S108).

The multi-modal input interpretation module 333 may deliver, to a voice interface, a dialog based on user intent (S110). The voice interface may output the dialog as a voice depending on whether the voice recognition/output mode is activated.

Furthermore, although not illustrated in the drawing, the multi-modal input interpretation module 333 may process the dialog based on the user intent as an image and deliver the image to the execution screen.

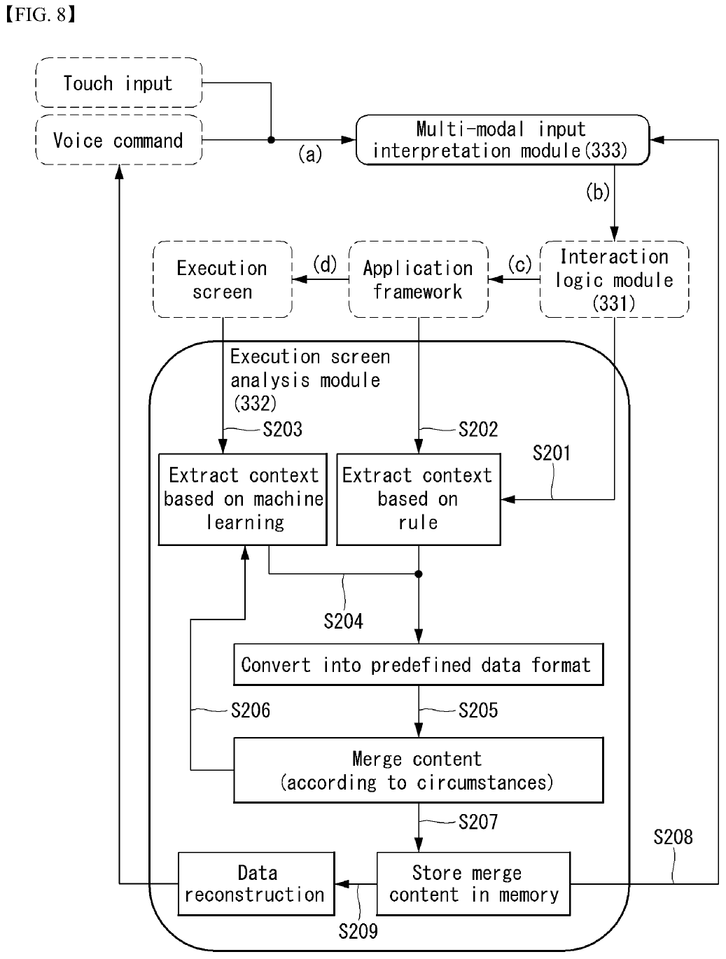

According to FIG. 8, it may be seen that an application operation according to a user input has been structured.

In a scenario of FIG. 8, a case where a user touches a button [A] now displayed on an App or gives a voice command (e.g., “Select A”) may be assumed (a). In this case, the multi-modal input interpretation module 333 may convert (e.g., CategorySelection, “A”) the voice command and the touch input into an event which may be handled by an application on the basis of user intent (b). In order to determine context for performing user feedback on the event, the multi-modal input interpretation module 333 may transmit the event to the interaction logic module 331 (c). An application framework may implement an image on an execution screen based on a method and content determined by the interaction logic module 331 (d).

In this case, the execution screen analysis module 332 may generate execution screen content according to a predetermined protocol whenever the execution screen context is generated (S201). Furthermore, the execution screen analysis module 332 may automatically extract context based on a predetermined Rule with respect to a specific execution screen format through the application framework (S202). Furthermore, the execution screen analysis module 332 may extract pattern information based on machine learning from an image or text displayed on the execution screen (S203).

The content extracted by using at least one of methods S201 to S203 may be normalized (context) into a predefined data format so that a system can use the content (S204). In this case, if there is the shortage or uncertainty of information between the pieces of extracted context, the execution screen analysis module 332 may merge the extracted context (S205). For example, if the application framework has automatically extracted list contents based on a rule, but a button capable of toggling based on machine learning is additionally discovered, the execution screen analysis module 332 may merge two pieces of context.

The merged context may update a dataset of machine learning (e.g., RNN) or may update the rule (S206). The merged context may be stored in the memory (S207), and may be used as context in a process of combining, interpreting, and extracting the results and data of natural language processing for a voice input within the execution screen analysis module 332 (S208). Furthermore, the merged context may be reconstructed as context for dynamically generating/updating a natural language processing model (S209).

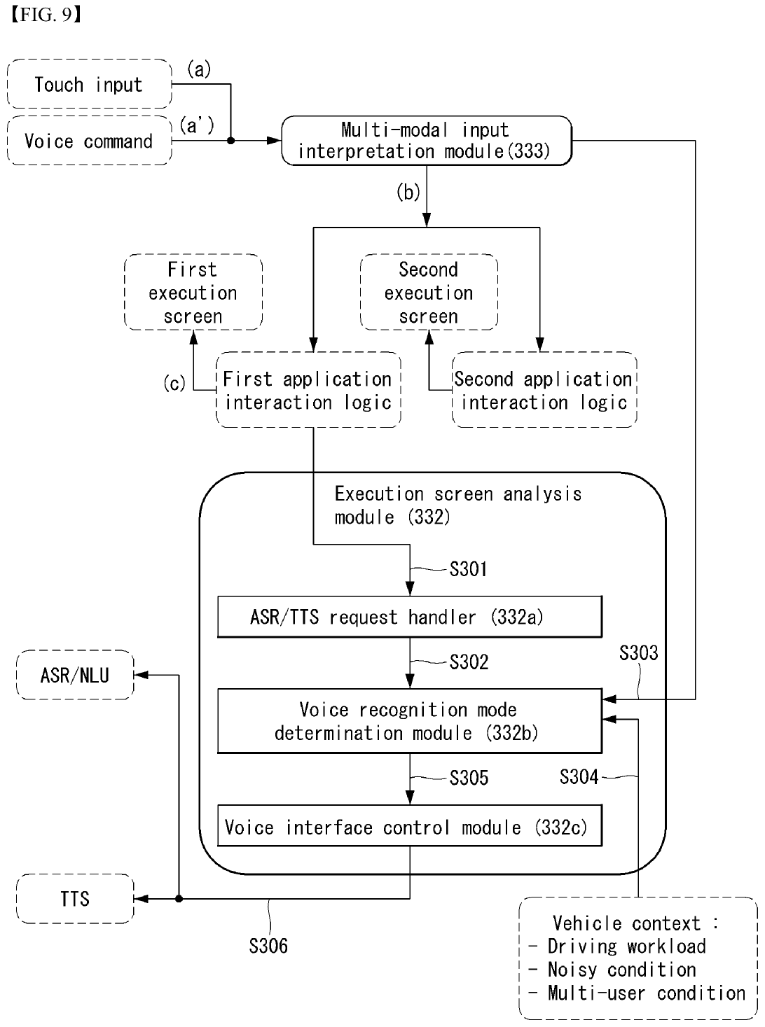

According to FIG. 9, a case where a user touches a button [A] now displayed on an App or gives a related voice command (e.g., “Select A”) may be issued (a, a′). In this case, the multi-modal input interpretation module 333 may convert the voice command and the touch input into an event which may be handled by an application based on user intent (e.g., CategorySelection, “A”), and may transmit the event to first application interaction logic and second application interaction logic (b). The converted event may be used to update a first execution screen and a second execution screen of two applications (c).

According to FIG. 9, an ASR/TTS request handler 332a of the execution screen analysis module 332 may receive TTS words from (the first and second applications) interaction logic. The request handler 332a may receive, from the interaction logic, information on whether subsequent voice recognition needs to be additionally required (S301).

A voice recognition determination module 332b may determine whether to actually deliver the requested TTS words to a TTS engine or to start an ASR engine when TTS is ended (S302).

For the above determination, if a user issues a command as a voice, the multi-modal input interpretation module 333 may activate the voice recognition mode (e.g., ASR ON, TTS ON)

For example, when the user speaks “Hi LG” or the user initiates a command as a touch input, the user may speak “Select Italian.” In this case, a POI search result screen is displayed on the execution screen. A TTS may be activated, and “Please select an item in the Italian restaurant list” may be spoken to the user. In this case, the ASR engine may be started, and a microphone may also be simultaneously activated. Such an activation state may continue to be maintained until a deactivation condition is satisfied.

Deactivation Condition:

1) Destination/stopover setting completed

2) Mode change by a touch input

3) Change of a task into another App

4) Cancellation by an error or user intent

The voice recognition mode determination module 332b may determine whether to activate the voice recognition mode by receiving vehicle context from a vehicle.

Vehicle Context

1) Driving workload

2) Noisy condition

3) Multi-user condition

Accordingly, the voice recognition mode determination module 332b may activate the voice recognition mode when a touch should not be made depending on a driving workload state. Furthermore, if it is determined the surrounding of a vehicle is a noisy environment due to noise, the voice recognition mode determination module 332b may transmit a guide message indicating the use of a manual interface (or touch interface), and may deactivate the voice recognition mode.

Furthermore, the voice recognition mode determination module 332b may tell TTS feedback of Private data only the user who has issued the voice command depending on whether another user is present, and may temporarily deactivate the voice recognition mode.

The voice recognition mode determination module 332b may transmit, to a voice interface control module 332c, AST/TTS Flag information and TTS words determined in the above process (S305). A voice interface control module 332c may sequentially drive an engine corresponding to an operation sequence (S306).

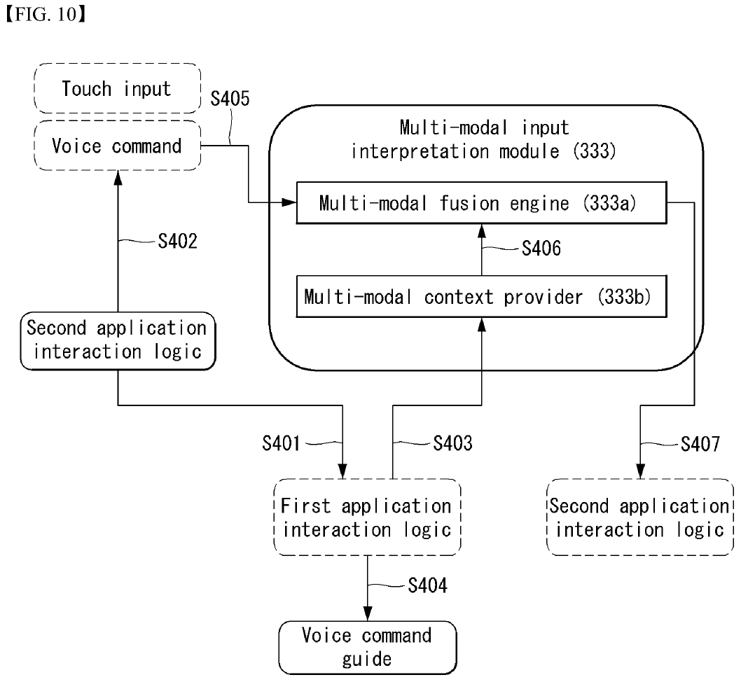

According to FIG. 10, a scenario that supports a voice-simultaneous input with respect to a manual operation on a predefined touch screen may be provided. Accordingly, a more convenient one-shot action function may be provided to a user.

When a pre-registered manual operation occurs on a touch screen, corresponding motion information may be delivered to an application through the application framework (S401). In this case, pre-registered motion information may include long press, knock-on, drawing circle, a multi-finger touch, etc.

A voice recognition engine may be randomly driven simultaneously by the manual operation (S402). When the first application interaction logic receives the manual operation, an operation according to pre-inputted context intent may be performed as follows.

A Context Example Driven According to the Manual Operation

1) Location GPS information upon long touch of a map

2) Information on an area in which a circle is drawn when the circle is drawn on the map

3) Corresponding item data information upon item knock-on on a list

4) Corresponding word information upon drawing of a specific portion of an edit window

The first application interaction logic may simultaneously support that a related voice command guide is generated (S404). In this case, the voice command guide may be as follows.

Voice Command Guide Example

1) When a map point is marked, “Go there/Find a parking close to here”

2) When a map circle is drawn, “Find cheapest gas in this region/Avoid this area”

3) When a specific item is knocked on in POI List results, “Call there”

4) When a specific word portion drawing operation is selected in the edit window, “Say a word to correct dictation”

The user input unit may recognize the voice command of the user and may transmit the results of the recognition to the multi-modal fusion engine 333a (S405). In this case, the multi-modal fusion engine 333a may receive data from the multi-modal context provider 333b, and may generate an event based on intent of the user (S406). In this case, the generated event may generate a UI scenario of the first application or the second application (S407).

The present disclosure described above may be embodied as computer-readable code on a medium on which a program is recorded. A computer-readable medium includes all kinds of recording devices in which data that may be read by a computer system is stored. Examples of the computer-readable media include a hard disk drive (HDD), a solid state disk (SSD), a silicon disk drive (SDD), a ROM, a RAM, a CD-ROM, a magnetic tape, a floppy disk, an optical data storage device, and the like. Further, the computer-readable media may include an implementation in a form of a carrier wave (e.g., transmission through Internet). Accordingly, the above detailed description should not be construed as limiting in all aspects and should be considered as illustrative. The scope of the present disclosure should be determined by reasonable interpretation of the appended claims and all changes that fall within the equivalent scope of the present disclosure are included in the present disclosure.

The aforementioned some embodiments or other embodiments of the present disclosure are not exclusive or different from each other. The elements or functions of the aforementioned some embodiments or other embodiments of the present disclosure may be jointly used or combined with each other.

The detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

1. A service provision device based on a multi-modal input, comprising:
a storage unit configured to store a plurality of applications;
a user input unit configured to receive a user input comprising at least one of a voice command or a touch input; and
a processor functionally connected to the plurality of applications and configured to control an execution of at least one application based on the user input so that a dialog generated by the plurality of applications is outputted by considering a pattern of the user input,
wherein the processor is configured to:
store a previous screen of an execution screen of a specific application in the storage unit while allocating a tag to the previous screen as a time stamp;
extract information on the execution screen and the previous screen;
infer intent of the user input by analyzing the information and the user input on the execution screen, and
control an application corresponding to the inferred intent to generate a dialog corresponding to the inferred intent.

2. The service provision device of claim 1, wherein the processor is configured to control the dialog to be generated as a voice based on the user input being the voice command.

3. The service provision device of claim 1, wherein the user input further comprises motion information.

4. The service provision device of claim 3, wherein the processor is configured to infer the intent by additionally considering the motion information.

5. The service provision device of claim 1, wherein the processor is configured to activate or deactivate the user input unit based on a preset condition.

6-7. (canceled)

9. The service provision device of claim 1, wherein the processor is configured to control the user input unit to switch into a voice recognition mode or a touch mode.

10. The service provision device of claim 1, wherein the processor is configured to infer the intent of the user input by analyzing the execution screen based on the intent of the user input being not inferred by analyzing the user input.

11. A service provision method based on a multi-modal input, comprising:
receiving a user input comprising at least one of a voice command or a touch input;
storing a previous screen of an execution screen of a specific application in a memory while allocating a tag to the previous screen as a time stamp;
extracting information on the execution screen and the previous screen;
inferring intent of the user input by analyzing the information and the user input on the execution screen;
controlling an application corresponding to the inferred intent to generate a dialog corresponding to the inferred intent; and
controlling an execution of at least one application so that the generated dialog is outputted by considering a pattern of the user input.

12. The service provision method of claim 11, wherein the dialog is outputted as a voice based on the user input being the voice command.

13. The service provision method of claim 11, wherein the user input further comprises motion information.

14. The service provision method of claim 13, wherein the inferring of the intent of the user input comprises inferring the intent by additionally considering the motion information.

15. The service provision method of claim 11, wherein the inferring of the intent of the user input comprises receiving the user input based on a user input unit being activated under a preset condition.

16-17. (canceled)

18. The service provision method of claim 11, wherein the receiving of the user input comprises:
controlling a user input unit to switch into a voice recognition mode and a touch mode based on a preset condition; and
receiving the user input.

19. The service provision method of claim 11, wherein the inferring of the intent of the user input comprises inferring the intent of the user input by analyzing the execution screen based on the intent of the user being not inferred by analyzing the user input.
